(19) United States
(12) Patent Application Publication
(10) Pub. No.: US 2005/0209843 A1
(43) Pub. Date: Sep. 22, 2005

(54) REMOTE TERMINAL EMULATION SYSTEM AND METHOD

(76) Inventor: Chin-Shuang Liu, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,523

(22) Filed: Jul. 19, 2004

(30) Foreign Application Priority Data
Mar. 19, 2004 (TW) 093107360

(51) Int. Cl. G06F 9/455

(52) U.S. Cl. 703/27

(57) ABSTRACT

A remote terminal emulation system includes an information converting apparatus including a serial signal interface electrically connected to a remote computer system for transmitting data in serial signal form, a network interface electrically connected to a network system for transmitting network packets, and a converting unit for converting data between serial signal form and network packet form. The remote terminal emulation system further includes a terminal emulation unit for presenting the data in serial signal form on the terminal of the remote computer system according to a terminal emulation method so as to provide a remote-control function when the remote computer system receives the data in network packet form from a host system via the network system.

### BACKGROUND OF INVENTION

1. Field of the Invention

The present invention relates to a remote terminal emulation system and more particularly, to a remote terminal emulation system for timely processing of remote terminal emulation to a host system via a network.

2. Description of the Prior Art

Please refer to FIG. 1. FIG. 1 is a functional block diagram of a computer system 5 such as a personal computer connected to a host system 1 via an RS-232 interface and a cable 3 having a 25-pin or 9-pin connector according to the prior art. Users can use a terminal installed on the computer system 5, such as a screen and an input device such as a mouse or a keyboard, for inspecting or operating the host system 1. The display information of the host system 1 and the control data inputted from the input device by users can be converted into RS-232 serial signals and be transmitted between the host system 1 and the computer system 5. That is what's known as a serial terminal. However, transmitted data might be lost due to an excessively long communication distance, so in general the cable 3 of the RS-232 interface can be several hundred feet at most. Thus, this requires that the computer system 5 be near the host system 1. As a result, this type of system is unsuitable for computer control between different areas of a telecommunication network, management of branches of a bank, remote management of a factory non-locally, etc.

To improve the above-mentioned problem, a widely used prior art technique is discussed as follows. Please refer to FIG. 2. FIG. 2 is a functional block diagram of a host system 2 connected to a computer system 8 via a terminal emulation protocol or a program corresponding with a terminal emulation protocol such as Telnet according to the prior art. Users can use a terminal installed on the computer system 8, such as a screen and an input device installed on the computer system 8 such as a mouse or a keyboard, for inspecting or operating the host system 2. The Telnet program installed on the host system 2 and the computer system 8 can convert data into data corresponding with the Telnet protocol, which can be transmitted between the host system 2 and the computer system 8 via a network system 6 such as the Internet or an intranet so as to inspect or operate the host system 2. However there is problem of data transmission safety. Since during the data transmission process the data are transmitted in a kind of source code, such as ASCII code, and there is no encrypting procedure during the data transmission process, user login data such as account numbers or passwords could be exposed. In addition, it is not convenient that the program corresponding with the foregoing terminal emulation protocol has to be installed on the host system 2 and the computer system 8, and that the compatibility of the program and operating systems also has to be considered.

### SUMMARY OF INVENTION

It is therefore a primary objective of the present invention to provide a remote terminal emulation system to solve the problems mentioned above.

According to the claimed invention, a remote terminal emulation system is disclosed for timely presenting data in serial signal form outputted from a host system on a terminal of a remote computer system via a network system. The remote terminal emulation system includes an information converting apparatus. The information converting apparatus includes a serial signal interface electrically connected to the remote computer system for transmitting the data in serial signal form, a network interface electrically connected to the network system for transmitting network packets, and a converting unit for converting data between serial signal form and network packet form. The remote terminal emulation system further includes a terminal emulation unit installed inside the remote computer system for presenting the data in serial signal form on the terminal of the remote computer system according to a terminal emulation method so as to provide a remote-control function when the remote computer system receives the data in network packet form from the host system via the network system.

According to the claimed invention, a remote terminal emulation system is disclosed. The remote terminal emulation system is installed between a host system with an operating system compatible with a UNIX operating system and a remote computer system with an operating system compatible with a WINDOWS operating system for timely presenting data outputted from the host system on a terminal of the remote computer system via a network system. The remote terminal emulation system includes an information converting apparatus for converting the data outputted from the host system into network packets to be transmitted on the network system, a terminal emulation unit installed inside the remote computer system for presenting the data outputted from the host system on the terminal of the remote computer system according to a terminal emulation method so as to provide a remote-control function when the remote computer system receives the data in network packet form from the host system via the network system, and a link unit installed inside the remote computer system and electrically connected to the terminal emulation unit for transferring the data obtained from the host system from the network system to the terminal emulation unit for terminal emulation processing.

According to the claimed invention, a method is disclosed for remote terminal emulation between a host system and a remote computer system. The method includes the following steps: inputting at least one data into the remote computer system; utilizing a terminal emulation unit of the remote computer system to present the data on a terminal of the remote computer system; transmitting the data in network packet form to an information converting apparatus via a network system; utilizing the information converting apparatus to convert the data in network packet form into serial signal form so as to transmit the data in serial signal form to the host system; and utilizing the host system to process the data in serial signal form.

According to the claimed invention, a method is disclosed for timely presenting data in serial signal form outputted from a host system on a terminal of a remote computer system via a network system. The method includes the following steps: utilizing the host system to output data in serial signal form; utilizing an information converting apparatus to convert the data in serial signal form into network packet form and transmitting the data in network packet to the remote computer system via the network system; utilizing a link unit of the remote computer system to transmit the data to a terminal emulation unit; and utilizing the terminal emulation unit to process the data according to a terminal emulation method and transmitting the data processed by the terminal emulation unit to the terminal of the remote computer system so as to present a virtual image.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a computer system connected to a host system via an RS-232 interface and a cable according to the prior art.

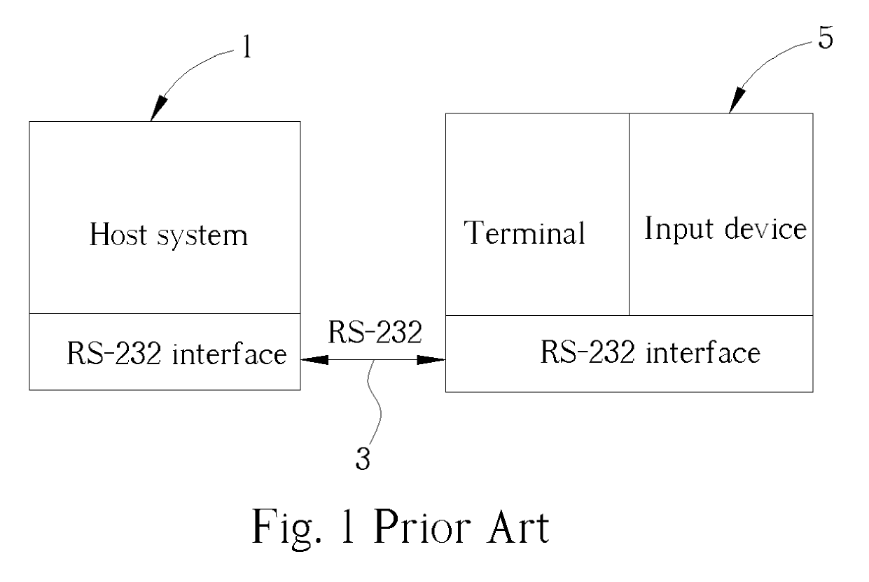

FIG. 2 is a functional block diagram of a host system connected to a computer system via a terminal emulation protocol or a program corresponding with a terminal emulation protocol according to the prior art.

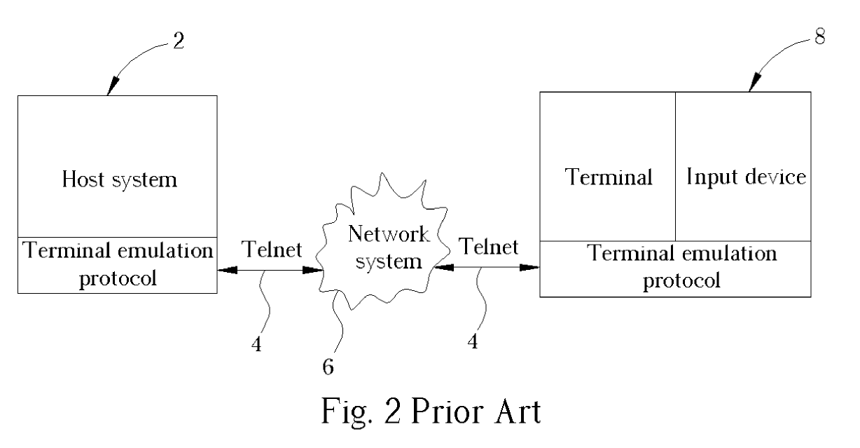

FIG. 3 is a functional block diagram of a remote terminal emulation system of a preferred embodiment according to the present invention.

FIG. 4 is a flowchart illustrating a remote terminal emulation method of the preferred embodiment according to the present invention.

FIG. 5 is a flowchart illustrating actions that a host system undertakes to respond to users after the host system finishes processing inputted data.

### DETAILED DESCRIPTION

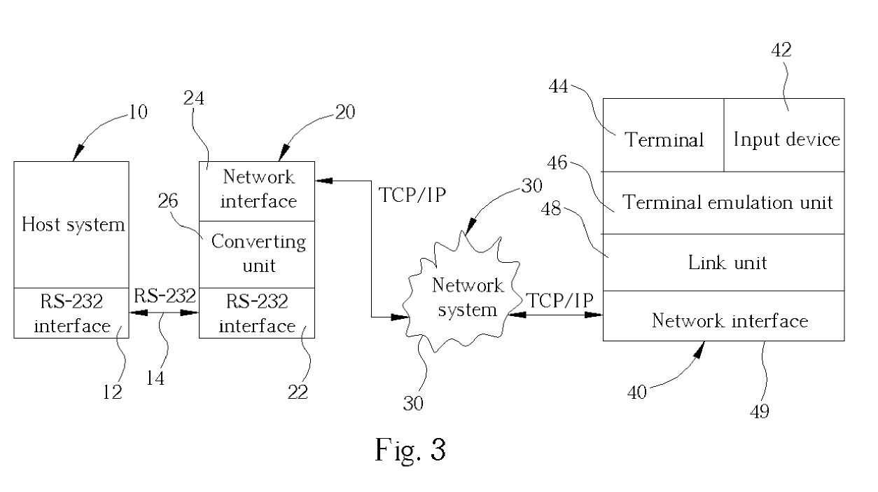

Please refer to FIG. 3. FIG. 3 is a functional block diagram of a remote terminal emulation system of a preferred embodiment according to the present invention. The remote terminal emulation system includes a host system 10 and a remote computer system 40. The remote terminal emulation system can present data outputted from the host system 10 on a terminal 44 of the remote computer system 40 quickly, that is, can process terminal emulation timely on the host system 10. The host system 10 includes an RS-232 interface 12 and an operating system compatible with a UNIX operating system. The remote computer system can be a personal computer and includes a WINDOWS operating system produced by Microsoft Corporation, an input device such as a keyboard, the terminal 44, and a network interface 49 corresponding with a TCP/IP communication protocol for electrically connecting to a network system 30.

The remote terminal emulation system further includes a terminal emulation unit 46, a link unit 48, and an information converting apparatus 20. The terminal emulation unit 46 is an application program installed inside the remote computer system 40 for presenting data transmitted from the host system 10 on the terminal 44 of the remote computer system 40 according to a terminal emulation method. The link unit 48 is also installed inside the remote computer system 40 and can be a socket designed with an ACTIVEX package. The link unit 48 is for connecting to the terminal emulation unit 46 and transferring the data outputted from the host system 10 from the network interface 49 to the terminal emulation unit 46 to be processed in terminal emulation, and for transferring the data inputted from the input device 42 of the remote computer system 40 by a user from the terminal emulation unit 46 to the network interface 49 so as to be outputted to the network system 30.

The information converting apparatus 20 electrically connected to the host system 10 and the network system 30 includes an RS-232 interface 22, a network interface 24 corresponding with a TCP/IP protocol, and a converting unit 26. The network interface 24 is electrically connected to the network system 30 for receiving network packets from the remote computer system 40 or transmitting network packets to the remote computer system 40. The RS-232 interface 22 is electrically connected to the RS-232 interface 12 of the host system 10 via a cable 14 with RS-232 connectors for transmitting serial signals to the host system 10 or receiving serial signals from the host system 10. It is important to note that the RS-232 interface 22 can include at least one RS-232 port and each RS-232 port is connected to one host system, so a plurality of RS-232 ports can be connected to many host systems so that the remote computer system 40 can monitor many host systems at the same time. The converting unit 26 includes a control unit, such as an AMR-based CPU, and a memory with an embedded firmware, such as flash memory, for converting data between RS-232 serial form and network packet form. For example, the converting unit 26 can convert the serial signals received by the RS-232 interface 22 into network packets corresponding to the TCP/IP protocol for being outputted by the network interface 24, and vice versa. In addition, the embedded firmware includes an operating system compatible with a Linux operating system and a crypto-module for encrypting and decrypting data transmitted between the host system 10 and the remote computer system 40 for providing data transmission safety on the network.

According to the present invention, the data outputted from the host system 10 can be transmitted to the information converting apparatus 20 for signal transferring processing in serial signal format via the cable 14, and then be converted into network packet form corresponding with the TCP/IP protocol. The data in network packet form can be transmitted to the remote computer system 40 via the network system 30. The link unit 48 of the remote computer system 40 can immediately transfer the data in network packet form to the terminal emulation unit 46 for processing terminal emulation, so that the data outputted from the host system 10 can be presented on the terminal 44 of the remote computer system 40 timely in a window framework for users to monitor. On the other hand, when a user inputs a command by the input device 42 of the remote computer system 40 to a host system 10, the process is the reverse of the above-mentioned one.

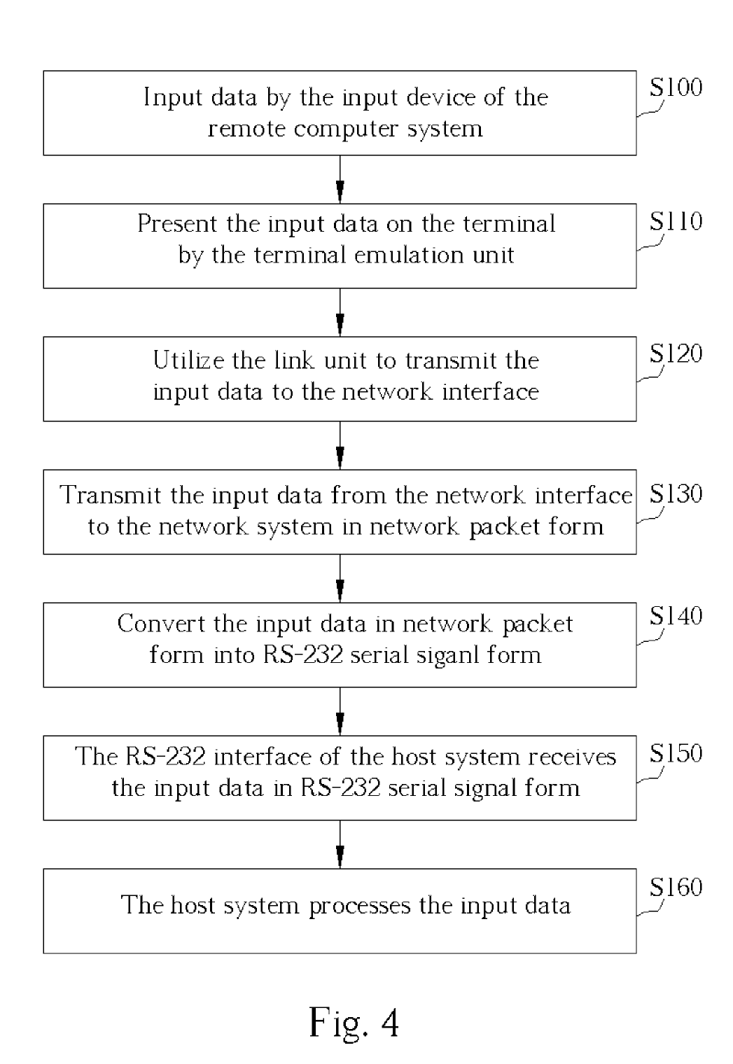

Please refer to FIG. 4. FIG. 4 is a flowchart illustrating a remote terminal emulation method of the preferred embodiment according to the present invention. The method includes the following steps:

Step 100: Input data that need to be processed by the host system 10, such as programming codes, by the input device 42, such as a keyboard of the remote computer system 40.

Step 110: Present the inputted data on the terminal 44 of the remote computer system 40 with the terminal emulation unit 46 so that a user can confirm the inputted data.

Step 120: The terminal emulation unit 46 utilizes the link unit 48 to transmit the inputted data to the network interface 49 corresponding with the TCP/IP protocol.

Step 130: Transmit the inputted data from the network interface 49 to the network system 30 in network packet form.

Step 140: Transmit the inputted data in network packet form to the network interface 24 of the information converting apparatus 20 via the network system 30, convert the inputted data in network packet form into RS-232 serial signal form by the converting unit 26 of the information converting apparatus 20, and output the inputted data in RS-232 serial signal form by the RS-232 interface 22 of the information converting apparatus 20.

Step 150: The RS-232 interface 12 of the host system 10 receives the inputted data in RS-232 serial signal form via the cable 14 so that the host system receives the inputted data.

Step 160: The host system 10 processes the inputted data.

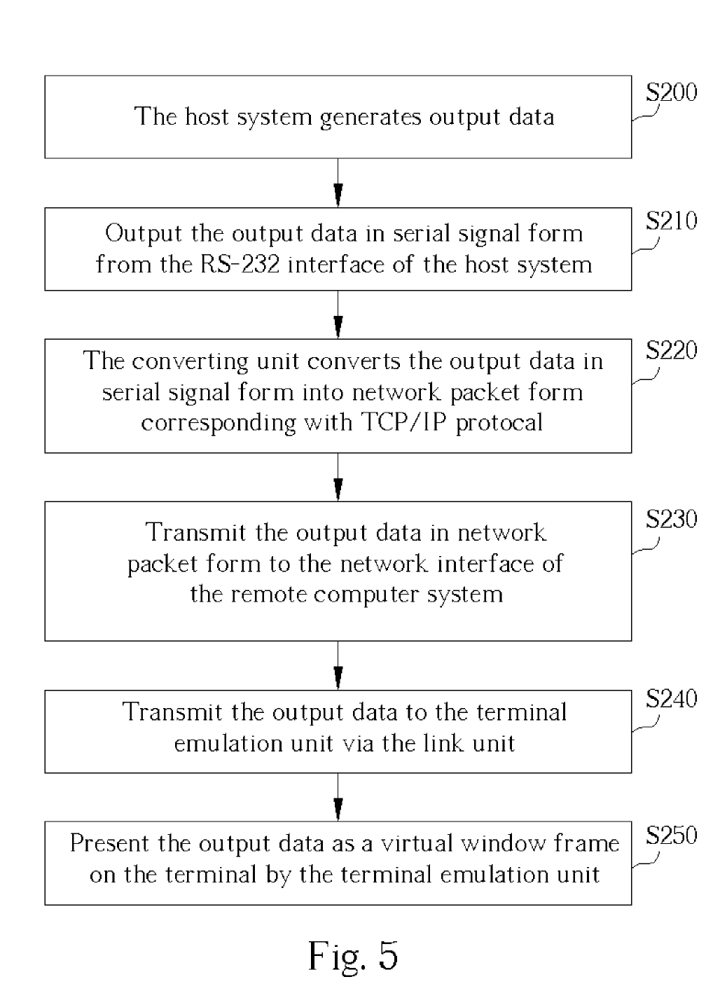

Furthermore, please refer to FIG. 5. FIG. 5 is a flowchart illustrating actions that the host system 10 undertakes to respond to users after the host system 10 finishes processing the inputted data. The method includes the following steps:

Step 200: The host system 10 generates output data.

Step 210: Output the output data in serial signal form from the RS-232 interface 12 of the host system 10.

Step 220: The RS-232 interface 22 of the information converting apparatus 20 receives the outputting data in serial signal form via the cable 14. The converting unit 26 converts the output data in serial signal form into network packet form corresponding with the TCP/IP protocol. The network interface 24 of the information converting apparatus 20 transmits the output data in network packet form to the network system 30.

Step 230: Transmit the output data in network packet form from the network system 30 to the network interface 49 of the remote computer system 40.

Step 240: Transmit the output data from the network interface 49 of the remote computer system 40 to the link unit 48, and then transmit the output data to the terminal emulation unit 46 to process terminal emulation.

Step 250: Present the output data as a virtual window frame on the terminal 44 of the remote computer system 40 with the terminal emulation unit 46 allowing a user to browse it.

In contrast to the prior art, the remote terminal emulation system and method according to the present invention can present data outputted from the host system 10 having an operating system compatible with a UNIX operating system on the terminal 44 of the remote computer system 40 having an operating system compatible with a WINDOWS operating system in a timely manner with the information converting apparatus 20, the terminal emulation unit 46, and the link unit 48. The host system 10 does not have to have any terminal emulation software installed. The present invention can allow users to inspect or operate the host computer 10 remotely and solves the limitation of RS-232 cable length in the prior art.

Those skilled in the art will readily observe that numerous modifications and alterations of the device and the method may be made while retaining the teachings of the invention. Accordingly, the above disclosure should be construed as limited only by the metes and bounds of the appended claims.

1. A remote terminal emulation system for timely presenting data in serial signal form outputted from a host system on a terminal of a remote computer system via a network system, the remote terminal emulation system comprising:
an information converting apparatus comprising:
a serial signal interface electrically connected to the remote computer system for transmitting the data in serial signal form;
a network interface electrically connected to the network system for transmitting network packets; and
a converting unit for converting data between serial signal form and network packet form; and
a terminal emulation unit installed inside the remote computer system for presenting the data in serial signal form on the terminal of the remote computer system according to a terminal emulation method so as to provide a remote-control function when the remote computer system receives the data in network packet form from the host system via the network system.

2. The remote terminal emulation system of claim 1 further comprising a link unit installed inside the remote computer system and electrically connected to the terminal emulation unit for transferring the data obtained from the host system via the network system from the network interface to the terminal emulation unit for terminal emulation processing.

3. The remote terminal emulation system of claim 2 wherein the link unit is a socket designed with an ACTIVEX package.

4. The remote terminal emulation system of claim 1 wherein the serial signal interface of the information converting apparatus is an RS-232 interface.

5. The remote terminal emulation system of claim 1 wherein the converting unit of the information converting apparatus includes a control unit and a memory with an embedded firmware for converting data between serial form and network packet form.

6. The remote terminal emulation system of claim 1 wherein the converting unit comprises an operating system (OS) compatible with a Linux operating system.

7. The remote terminal emulation system of claim 1 wherein the converting unit comprises a crypto-module for encrypting and decrypting data transmitted between the host system and the remote computer system.

8. A remote terminal emulation system installed between a host system with an operating system compatible with a UNIX operating system and a remote computer system with an operating system compatible with a WINDOWS operating system for timely presenting data outputted from the host system on a terminal of the remote computer system via a network system, the remote terminal emulation system comprising:
an information converting apparatus for converting the data outputted from the host system into network packets to be transmitted on the network system;
a terminal emulation unit installed inside the remote computer system for presenting the data outputted from the host system on the terminal of the remote computer system according to a terminal emulation method so as to provide a remote-control function when the remote computer system receives the data in network packet form from the host system via the network system; and
a link unit installed inside the remote computer system and electrically connected to the terminal emulation unit for transferring the data obtained from the host system from the network system to the terminal emulation unit for terminal emulation processing.

9. The remote terminal emulation system of claim 8 wherein the information converting apparatus comprises:
a serial signal interface electrically connected to the remote computer system for transmitting the data in serial signal form;
a network interface electrically connected to the network system for transmitting the data in network packet form; and
a converting unit for converting data between serial signal form and network packet form.

10. The remote terminal emulation system of claim 8 wherein the link unit is a socket designed with an ACTIVEX package.

11. A method for remote terminal emulation between a host system and a remote computer system, the method comprising:
inputting at least one data into the remote computer system;
utilizing a terminal emulation unit of the remote computer system to present the data on a terminal of the remote computer system;
transmitting the data in network packet form to an information converting apparatus via a network system;
utilizing the information converting apparatus to convert the data in network packet form into serial signal form so as to transmit the data in serial signal form to the host system; and
utilizing the host system to process the data in serial signal form.

12. The method of claim 11 wherein the host system comprises an operating system compatible with a UNIX operating system, and an RS-232 interface electrically connected to the information converting apparatus for transmitting the data in serial signal from.

13. The method of claim 11 wherein the remote computer system comprises an operating system compatible with a WINDOWS operating system, and an input device for allowing a user to input data.

14. The method of claim 11 wherein the remote computer system comprises a network interface corresponding with a TCP/IP protocol and electrically connected to the network system for transmitting the data in network packet form.

15. The method of claim 11 further comprising utilizing a link unit connected to the terminal emulation unit for transferring the data from the terminal emulation unit to the network system, wherein the link unit is a socket designed with an ACTIVEX package.

16. The method of claim 11 wherein the information converting apparatus further comprises a serial signal interface electrically connected to the host system for transmitting the data in serial signal form, a network interface electrically connected to the network system for transmitting the data in network packet form, and a converting unit for converting data between serial signal form and network packet form.

17. A method for timely presenting data in serial signal form outputted from a host system on a terminal of a remote computer system via a network system, the method comprising:
utilizing the host system to output data in serial signal form;
utilizing an information converting apparatus to convert the data in serial signal form into network packet form and transmitting the data in network packet to the remote computer system via the network system;
utilizing a link unit of the remote computer system to transmit the data to a terminal emulation unit; and
utilizing the terminal emulation unit to process the data according to a terminal emulation method and transmitting the data processed by the terminal emulation unit to the terminal of the remote computer system so as to present a virtual image.

18. The method of claim 17 wherein the remote computer system comprises a network interface corresponding with a TCP/IP protocol and electrically connected to the network system for transmitting the data in network packet form.

19. The method of claim 17 wherein the link unit is a socket designed with an ACTIVEX package.

20. The method of claim 17 wherein the information converting apparatus further comprises a serial signal interface electrically connected to the host system for transmitting the data in serial signal form, a network interface electrically connected to the network system for transmitting the data in network packet form, and a converting unit for converting data between serial signal form and network packet form.
